(19) United States
(12) Patent Application Publication
(10) Pub. No.: US 2008/0054691 A1
(43) Pub. Date: Mar. 6, 2008

(54) Web adjuster assembly

(75) Inventor: Richard W. Glover, Greenwood, IN (US)

Correspondence Address: ICE MILLER LLP, ONE AMERICAN SQUARE, SUITE 3100, INDIANAPOLIS, IN, 46282-0200, US

(73) Assignee: Cosco Management Inc., (a Delaware corporation), Wilmington, DE (US)

(21) Appl. No.: 11/511,831

(22) Filed: Aug. 29, 2006

(51) Int. Cl. B60N 2/28

(52) U.S. Cl. 297/250.1; 297/468; 297/484

(57) ABSTRACT

Disclosed is a web adjuster assembly to allow tightening of a strap while preventing microslip of the strap when the web adjuster assembly is closed. The web adjuster assembly uses a second plate hingedly biased against a first plate with a strap laced through an opening on the first plate and through openings on the second plate such that when the two plates are substantially resting against one another, friction prevents the strap from being pulled back through the web adjuster assembly. However, simply lifting the second plate away from the first plate in an arc allows the strap to travel back through the web adjuster assembly, thereby allowing the strap to loosen.

### BACKGROUND

The present invention relates generally to web adjusters, and particularly to web adjusters used with child restraints.

One-way locking belt adjusters, referred to herein as “web adjusters,” are well known in the art. Web adjusters typically comprise a metallic or plastic housing with a strap threaded therein, allowing for the adjustment of the length of one or more portions of a strap. Various web adjusters exist in the art, including those with pull mechanisms, push mechanisms, roller mechanisms, allowing for the securing or releasing of a strap.

Child restraints used in automobiles and other vehicles are also well known in the art. Child restraints designed for use in an automobile typically have a seat shell covered with fabric and cushioning in which a child sits, and an adjustable harness web for restraining and securing a child in the seat shell. Various seat shell configurations exist in the art, including seat shells with an open front, such as those shown in U.S. Pat. No. 6,695,412 to Barger (the “Barger patent”) and U.S. Pat. No. 4,886,315 to Johnson (the “Johnson patent”).

In one commonly used configuration, similar to that shown in the Barger patent, a seat shell having an open front utilizes a web harness assembly comprising a first, second, and third strap forming a “Y” wherein the first and second straps fit over a child's shoulders and the third and lower strap fits between a child's legs when the web harness assembly is properly utilized. The first and second straps may have a clip at each end, and may releasably be engaged by a Y buckle coupled to the third strap. Typically, the Y buckle meets at approximately the lap, stomach, or chest area of the child when the web harness assembly is properly engaged. The Y buckle allows one end of each of the straps to be releasably secured by way of a push button or push buttons so that the child may be easily secured in the seat when the restraint is in use, and easily removed thereafter.

An important aspect of the child restraint lies in the ability to adjust the length of the harness web to snugly yet comfortably secure children of differing sizes in the restraint. It is well known in the art that this may be accomplished by many means, but adjustment of the harness web is usually done by way of adjusting the length of the first and second straps (the shoulder straps) by pulling or releasing the first or second straps through openings in the seat shell on either side of the child's head such that the Y buckle is pulled in an upward direction and back toward the rear of the seat when the first and second straps are tightened. Optionally, adjustment may be made by pulling the third strap through an opening in the bottom of the seat shell such that the Y buckle is pulled down when the third strap is tightened.

Regardless of whether the first and second straps and/or the third strap are used to adjust the length and tension of the harness, a web adjuster is used to loosen or tighten the strap(s). Prior art web adjusters have comprised many different configurations, including buckles, clamps and cam adjusting mechanisms, and more complex spring-biased mechanisms similar to those shown in the Barger patent. The prior art cam mechanisms typically have a rotating cam that is spring biased to pivot to compress the web belt between a ridged surface of the cam and an opposing surface of the mechanism. The spring biasing allows the web to be pulled through the cam adjusting mechanism in one direction, while impeding the strap from slipping back through the cam adjusting mechanism in the opposite direction (“microslip”) unless the cam is released by pressing on a release lever arm of the cam to cause the ridged surface of the cam to pivot away from the web and disengage the web. Thus, the web harness can be adjusted after the child is placed in the seat and the straps are secured to the Y buckle. This is accomplished by pulling on the end of the strap that extends out of the adjuster's cam mechanism, thereby tightening the first strap against the child's shoulders.

While cam and other adjusters known in the art, such as those described above, have been used in the past, an alternative adjuster for adjusting the straps of a web harness would be appreciated in the art. In particular, an adjuster of simplified construction and reduced cost of manufacture would be greatly appreciated. Further, an adjuster allowing greater ease of use over the cam adjusters would be greatly appreciated.

### SUMMARY OF THE INVENTION

The present invention relates generally to web adjusters, and particularly to web adjusters used with child restraints.

In an embodiment of the present invention, the adjuster assembly for adjusting the length of a strap comprises a first plate having a first plate first edge, and at least one first strap opening formed therethough, a second plate having a second plate first edge and at least two second strap openings formed therethrough, a hinge coupled to the first plate at the first edge of the first plate and to the second plate at the first edge of the second plate, said hinge allowing the first plate and second plate to pivot with respect to one another, wherein one end of the strap is threaded through the at least one first strap opening in the first plate, though one of the at least two strap openings in the second plate, then back through a second of the at least two strap openings in the second plate, and then back through the first opening in the first plate so that the strap can be freely pulled through the adjuster in one direction but when pulled in the opposite direction causes the first and second plates to pivot toward one another to prevent the strap from being pulled back thought the adjuster in the opposite direction unless and until the second plate is manually pivoted away from the first plate.

In one embodiment, the adjuster assembly further comprises biasing means for biasing the first plate and the second plate to pivot toward one another. In another embodiment, the biasing means comprises a spring coupled to the first plate and the second plate.

In an additional embodiment, the adjuster assembly further comprises a cover plate mounted over the second plate. In another embodiment, the cover plate further comprises a grip portion. In yet another embodiment, the cover plate further comprises indicia printed or embossed thereon. In an additional embodiment, the cover plate is removably attached to the second plate. In another embodiment, the second plate further comprises a second plate spacer, the second plate spacer connected at a first edge to the first edge of the second plate and the hinge is connected to the second plate spacer at an opposite second edge of said spacer, the second plate spacer off setting the second plate with respect to the first plate. In yet another embodiment, a second end of the elongated strap is attached to the first plate to form a loop at a position that does not interfere with the first end of the strap being pulled though the adjuster so that as said first end of the strap is pulled through the adjuster assembly, the length of the loop of the strap is reduced.

Another embodiment of the present invention comprises a child restraint comprising a shell comprising a seat portion and a back portion, a harness system mounted to said seat for restraining a child in said seat, said harness system comprising shoulder straps passing over the shoulders of a child when positioned in said seat and said shoulder straps passing through said back portion, said shoulder straps being connected to an adjusting strap that passes under said seat portion, an adjuster assembly coupled to a front portion of the shell, the adjuster assembly comprising a first plate having a first edge, and at least one first opening formed therethrough, a second plate having a first edge, and at least two second openings formed therethrough, a hinge coupled to the first edge of the first plate and to the first edge of the second plate, said hinge allowing the first plate and the second plate to pivot with respect to one another so that said first opening is offset from said second openings, said adjusting strap being threaded through the at least one first opening in the first plate, through one of the at least two strap openings in the second plate, then back through a second of the at least two openings in the second plate, and then back through the first opening in the first plate so that the strap can be pulled through the adjuster assembly in one direction but movement of said strap in the opposite direction causes the first and second plates to pivot toward one another to prevent the strap from being pulled back through the adjuster in the opposite direction unless and until the second plate is pivoted away from the first plate.

In one embodiment, the web harness assembly comprises a crotch strap connected to a Y buckle and said shoulder straps are removably connected to said Y buckle. In an additional embodiment, the child restraint further comprises biasing means for biasing the first plate and the second plate to pivot towards one another. In yet another embodiment, the biasing means comprises a spring coupled to the first plate and the second plate.

In an additional embodiment, the child restraint further comprises a cover plate mounted over the second plate. In yet another embodiment, the cover plate further comprises a grip portion. In an additional embodiment, the cover plate further comprises indicia printed or embossed thereon. In yet another embodiment, the second plate further comprises a second plate spacer, the second plate spacer connected at a first edge to the first edge of the second plate and the hinge is connected to the second plate spacer at an opposite second edge of said spacer, the second plate spacer off setting the second plate with respect to the first plate.

### BRIEF DESCRIPTION OF THE DRAWINGS

The features and advantages of this invention, and the manner of attaining it, will be more apparent and better understood by reference to the following descriptions taken in conjunction with the accompanying drawings, wherein:

FIG. 1 shows an upper perspective view of a plate assembly, tension spring, and cover plate;

FIG. 2A shows a top view of one embodiment of a plate assembly;

FIG. 2B shows a top view of another embodiment of a plate assembly;

FIG. 3 shows an upper perspective view of the plate assembly of FIG. 1 in an open position, assembled with a strap lacing through the plate assembly;

FIG. 4 shows an upper perspective view of the plate assembly and strap of FIG. 3 in a closed position, and having a tension spring installed thereon;

FIG. 5 shows an upper perspective view of the plate assembly and strap of FIG. 4 with a cover plate attached to the plate assembly;

FIG. 6 shows a right front perspective view of a child restraint with an adjuster assembly attached;

FIG. 7 shows a right front perspective view of a child restraint with an adjuster assembly and a web harness assembly attached;

FIG. 8 shows a left front perspective view of the receiving area of the child restraint shell of FIG. 6 without the adjuster assembly attached;

FIG. 9 shows a right front perspective view of a portion of the child restraint of FIG. 6, showing the adjuster assembly being lifted to its released position; and

FIG. 10 shows a front perspective view of a portion of the child restraint of FIG. 6, showing the adjuster assembly in its closed position.

### DESCRIPTION

The present invention relates generally to web adjusters, and particularly to web adjusters used with child restraints. While the following description of the preferred embodiment of the present invention is intended to provide an understanding of the principles and significant features of the present invention, it is not intended to limit the scope of the invention intended hereby. Various alterations, modifications and changes to the embodiment described herein can be made without departing from the spirit and scope of the present invention and will be apparent to those of ordinary skill in the art.

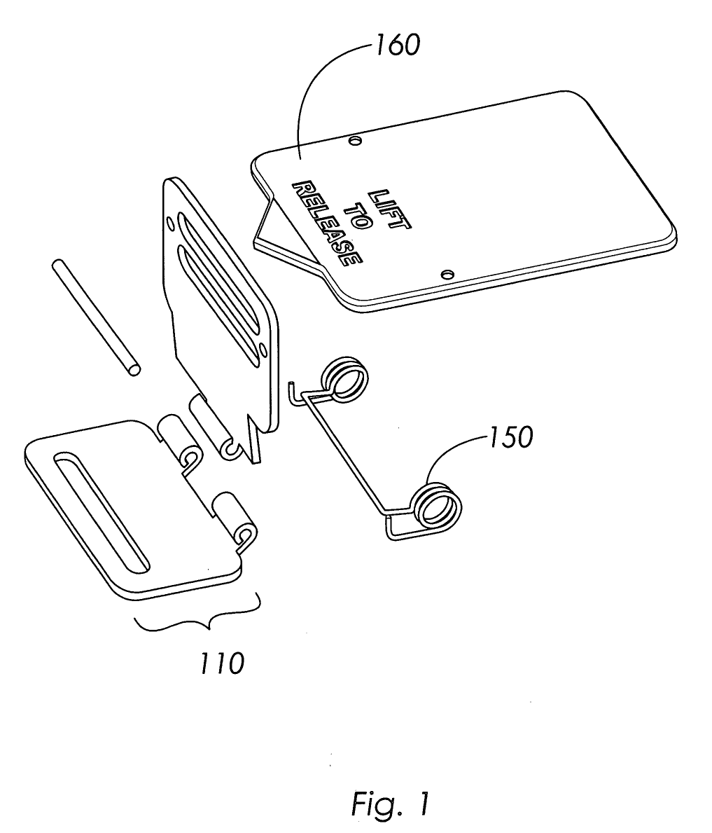

With reference to FIG. 1, one embodiment of adjuster assembly 100 is shown comprising a plate assembly 110, tension spring 150, and a cover plate 160.

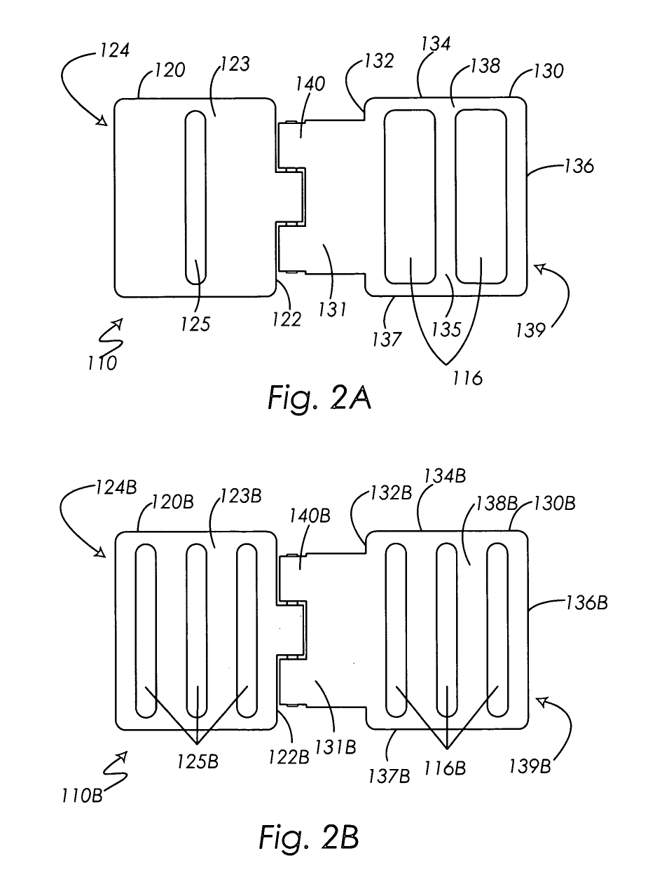

With reference to FIG. 2A, plate assembly 110 comprises a first plate 120, a second plate 130, and a hinge 140. It will be appreciated by one skilled in the art, the first plate 120, the second plate 130 and the hinge 140 may be fabricated from metal, plastic, or another material suitable for the particular application. The first plate 120 has at least one opening 125 formed therein. First plate 120 also has a first edge 122 adjacent to hinge 140, a first surface 123, and a second surface 124 (on the opposite side of first plate 120). The second surface 124 of first plate 120 is denoted in FIG. 2A by a curved arrow representing the presence of the second surface 124 on the opposite side of the first surface 123 of first plate 120. The first plate 120 is connected to the hinge 140 at the first edge 122.

The second plate 130 has a second plate spacer 131 extending from first edge 132 of second plate 130. Second plate 130 is essentially rectangular having a second edge 134, a third edge 136, a fourth edge 137, and a first surface 138. Second plate 130 has a second surface 139 denoted in FIG. 2A by a curved arrow representing the presence of the second surface 139 on the opposite side of the second plate 130 opposite the first surface 138. The second plate 130 is coupled to the hinge 140 by the second plate spacer 131. It will be appreciated by one skilled in the art that the second plate 130 is offset from first plate 120 by second plate spacer 131, so that second plate 130 does not precisely overlap first plate 120 when pivoted around the hinge 140.

Second plate 130 has at least two openings 116 formed through second plate 130 (as shown in FIG. 2A), the purpose for which will be described below.

FIG. 2B also shows an alternative embodiment of a plate assembly 110B having a first plate 120B with three openings 125B, and second plate 130B with three openings 116B formed therethrough, the purpose for which will be described below.

In the alternative embodiment of the plate assembly 110B in FIG. 2B, the first plate 120B also has a first edge 122B adjacent to hinge 140B, a first surface 123B, and a second surface 124B (on the opposite side of first plate 120B). The second surface 124B of first plate 120B is denoted in FIG. 2B by a curved arrow representing the presence of the second surface 124B on the opposite side of the first surface 123B of first plate 120B. The first plate 120B is connected to the hinge 140B at the first edge 122B. The second plate 130B has a second plate spacer 131B extending from first edge 132B of second plate 130B. Second plate 130B is essentially rectangular having a second edge 134B, a third edge 136B, a fourth edge 137B, and a first surface 138B. Second plate 130B has a second surface 139B denoted in FIG. 2B by a curved arrow representing the presence of the second surface 139B on the opposite side of the second plate 130 opposite the first surface 138B. The second plate 130B is coupled to the hinge 140B by the second plate spacer 131B. It will be appreciated by one skilled in the art that the second plate 130B is offset from first plate 120B by second plate spacer 131B, so that second plate 130B does not precisely overlap first plate 120B when pivoted around the hinge 140B.

It will be appreciated by one skilled in the art that portions of the hinge 140 or 140B may be integrally formed with the first plate 120 or 120B and second plate spacer 131 or 131B of second plate 130 or 130B. For example, the first edge 122 of plate 120 may have a first portion of a hinge formed therein, and the second plate spacer 131 extending from first edge 132 may define a corresponding second portion of a hinge. Hinge 140 and 140B couple first plate 120 or 120B to second plate 130 or 130B by means well known in the art, including a hinge pin or a rotating snap mechanism, which hold the first plate 120 and the second plate 130 together while allowing the plates to pivot at the hinged portions of each plate.

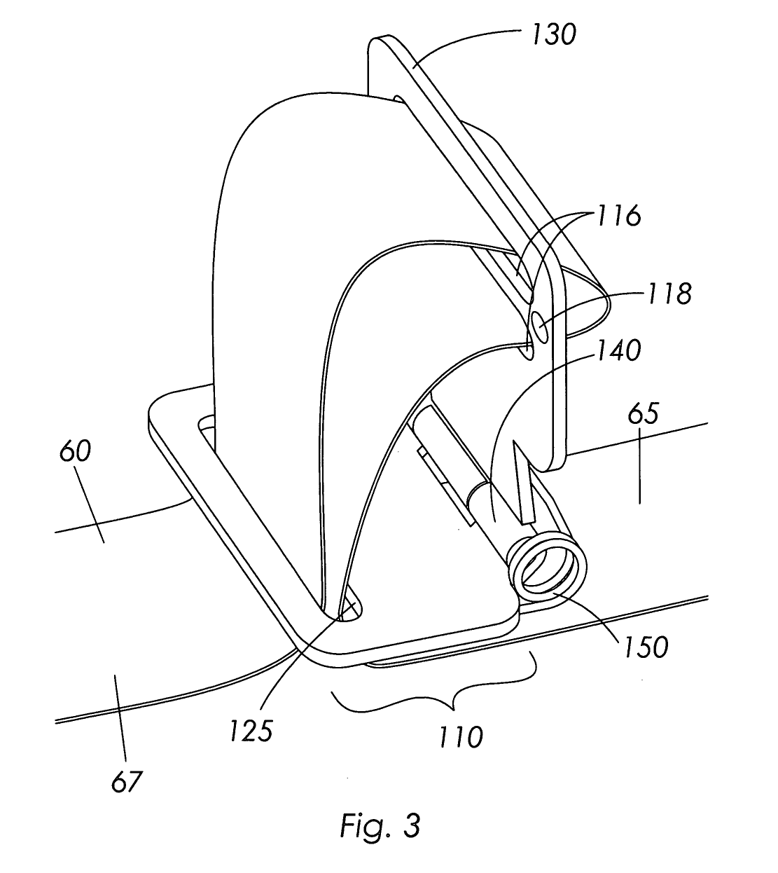

FIG. 3 shows plate assembly 110 with a strap 60 threaded through first plate 120 and second plate 130. The term “strap” is used generally herein and may include, but is not limited to, any number of adjustment straps, belts, ropes, wires, and the like, that may be threaded through a plate assembly 110. In this embodiment, strap 60 is a flexible elongated fabric strap having a first end 65 and a second end 67. Strap 60 is laced through plate assembly 110 by lacing the first end 65 of strap 60 through the opening 125 of the first plate, entering the opening 125 from the second surface 124 side of the first plate 120. The first end 65 of strap 60 is then laced through the opening 116 closest to the third edge 136 of second plate 130 around bar 135, entering opening 116 from the first surface 138 side of the second plate 130. The first end 65 of strap 60 is then laced through the second opening 116 in the second plate 130, entering the second opening 116 from the second surface 139 side of the second plate 130. The first end 65 of strap 60 may then be laced through the same opening 125 from the first surface 123 side of the first plate 120. The first end 65 of strap 60 may then be pulled through plate assembly 110 as shown in FIG. 3.

It will be appreciated by one skilled in the art that the second end 67 of strap 60 may be laced through plate assembly 110 in reverse order as the first end 65 may be laced through plate assembly 110 as described above, achieving the same result. It may also be appreciated that strap 60 can be threaded through the embodiment of FIG. 2B by lacing the first end 65 of the strap 60 through one of the openings 125B of first plate 120B, through opening 116B closest to third edge 136B or the middle opening 116B of second plate 130B, back through the middle opening 116B or the opening 116B closest to the first edge 132B of second plate 130B if initially laced through opening 116B closest to third edge 136B, or back through the opening 116B closest to the first edge 132B of plate 130B if initially laced through the middle opening 116B, and back through an opening 125B in the first plate 120B in a substantially similar fashion as strap 60 may be laced through plate assembly 110.

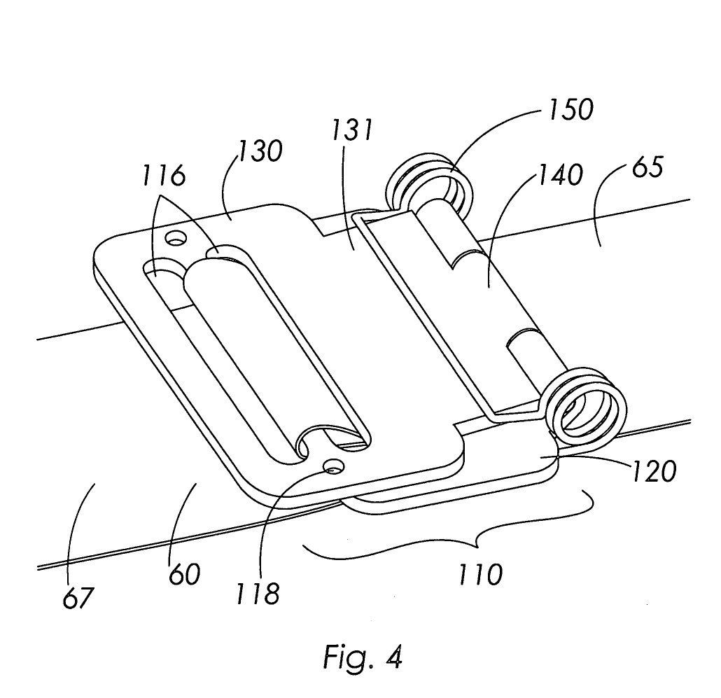

FIG. 4 shows plate assembly 110 with strap 60 threaded therethrough and tension spring 150 biasing first plate 120 and second plate 130 toward one another. Any means known in the art for biasing the first plate 120 and the second plate 130 of the plate assembly 110 toward one another may be used. In this embodiment, strap 60 is pulled through plate assembly 110 as described above, causing the first surface 124 of the first plate 120 and the first surface 138 of the second plate 130 to face one another. Tension spring 150 may be fixedly or removably coupled to the first plate 120 at the second surface 124 of the first plate 120 and the second plate spacer 131. Tension spring 150 biases the first plate 120 and the second plate 130 toward one another pinching the belt between the two plates.

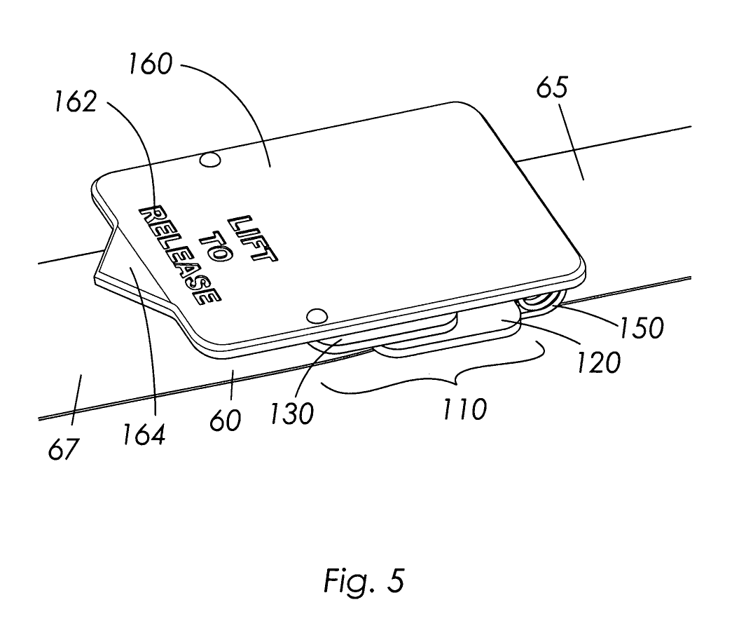

FIG. 5 shows plate assembly 110 with a cover plate 160 positioned over the top of second plate 130. Cover plate 160 may have indicia 162 printed or embossed thereto. A grip portion 164 extends from cover plate 160 to provide a surface to be engaged by the user's fingers to lift the second plate 130 to release strap 60. Cover plate 160 may be removably or fixedly attached to the second plate 130 at one or more of the second plate's 130 first edge 132, second edge 134, third edge 136 or fourth edge 137. Cover plate 160 may also be attached through cover plate openings 118 (as shown in FIGS. 3 and 4) formed through the first surface 138 of the second plate 130, and the second surface 139 of the second plate 130. Cover plate 160 may be removably or fixedly attached to the second plate 130 by any means well known in the art, including but not limited to fasteners, rivets, flanges or snaps. Indicia 162 may be provided on the cover plate 160, and indicia 162 may provide instruction to a user, such as “LIFT TO RELEASE.” It will be appreciated by one skilled in the art that the cover plate 160 may be fabricated from metal, plastic, or another material suitable for the particular application.

It should be appreciated that adjuster assembly 100 may be used to adjust the length of a strap 60 used to encompass luggage, suitcases, baggage, etc. It should also be appreciated that adjuster assembly 100 may be used to adjust the length of a strap of a Lower Anchors and Tethers for Children (LATCH) assembly. In that case, the strap 60 would be passed through adjuster assembly 100 at one end, but looped and attached to the first plate 120 at the other end to form a loop of strap 60 that could be placed around the luggage, suitcases, baggage, etc. The strap 60 would be attached to the first plate 120 at a point that would not interfere with the movement of the strap 60 through the adjuster assembly 100 such as at first edge 122 so that the length of the loop could be adjusted by pulling the strap 60 through the adjuster assembly 100 without interference. The length of the loop of strap 60 could be reduced to tighten the strap 60 by pulling the strap through adjuster assembly 100 until all slack is removed, and the strap loosened by pivoting the second plate 130 away from the first plate 120 so that the strap 60 can be moved in the opposite direction.

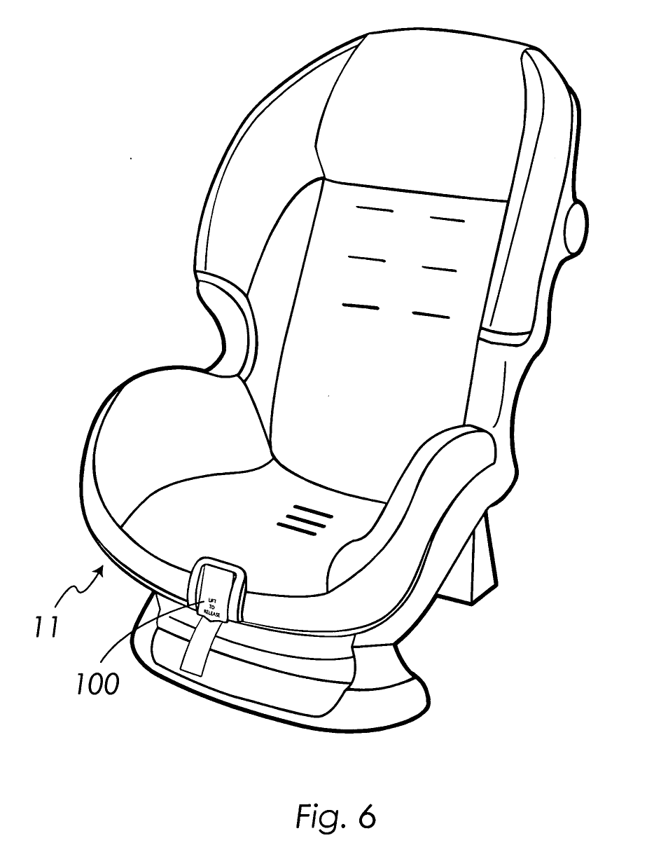

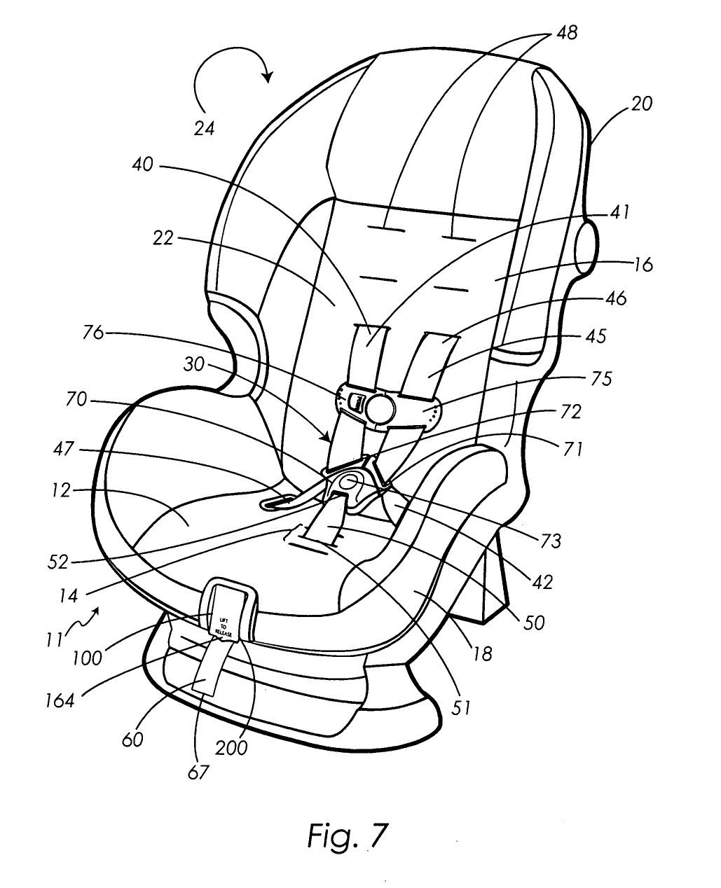

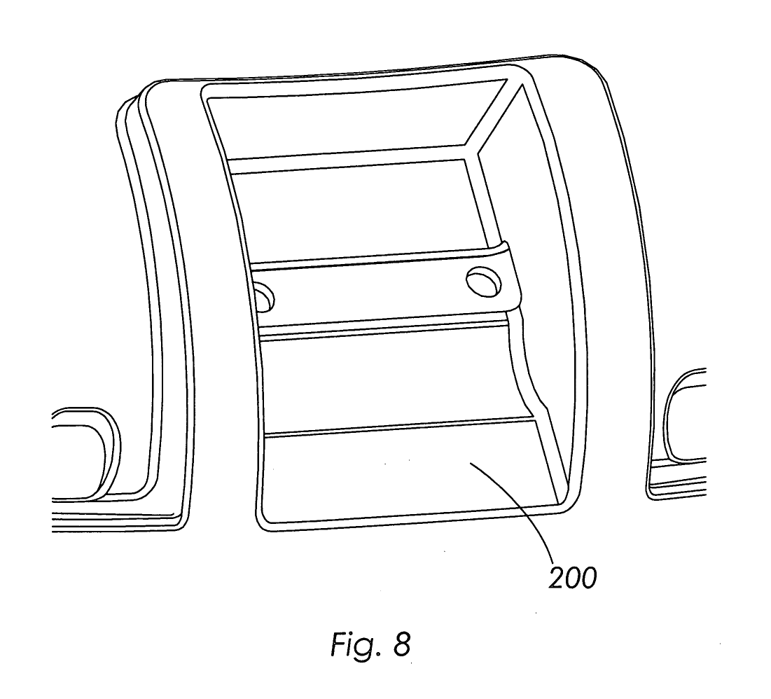

FIGS. 6 and 7 show an embodiment of the adjuster assembly 100 coupled to a child restraint 11. It will be appreciated by one skilled in the art that the adjuster assembly 100 may be used in several applications, including but not limited to child restraints, seat belts, clothing belts, suitcase straps, and potentially any other application requiring a harness and/or adjuster means. According to this embodiment, and as shown in FIG. 7, child restraint 11 comprises a shell 20 having a seat portion 12 having at least three seat openings 14; a back portion 16 defining at least two back openings 48, a front surface 22, a rear surface 24; and a receiving surface 200 (as shown in FIG. 8). Child restraint 11 has a web harness assembly 30 and the adjuster assembly 100 mounted thereon. Child restraint 11 may further comprise a seat cushion 18, which may be positioned on the front surface 22 of the shell 20 and secured to shell 20 by means known in the art.

The web harness assembly 30 comprises a first shoulder strap 40, a second shoulder strap 45, a crotch strap 50, strap 60, and a releasable Y buckle 70. In the embodiment of FIG. 7, first shoulder strap 40 has first end 41 and second shoulder strap 45 has first end 46 which pass through back openings 48 of shell 20, entering the back openings 48 of shell 20 from the front surface 22 of shell 20. The first end 41 of the first shoulder strap 40 and the first end 46 of the second shoulder strap 45 may then be coupled together behind the back portion 16 of shell 20 to adjusting strap 60. The first end 41 of the first shoulder strap 40 and the first end 46 of the second shoulder strap 45 may be fixedly or removably coupled to a connecting bar (not pictured) behind the back portion 16 of shell 20 which in turn is connected to adjusting strap 60. Alternatively, first end 41 of first shoulder strap 40 and first end 46 of second shoulder strap 45 may be coupled to adjusting strap 60 behind the back portion 16 of shell 20 by sewing the ends of all three together. It will be appreciated by one skilled in the art that first shoulder strap 40 and second shoulder strap 45 may comprise one continuous strap or may be separate straps.

A first shoulder strap 40 passes through tongue clip 71, and a second shoulder strap 45 passes through tongue clip 72. The tongue clips 71 and 72 are removably coupled to Y buckle 70 and may be released by pressing button 73 on Y buckle 70. The first shoulder strap 40 and the second shoulder strap 45 may either be fixedly or removably coupled at opposite sides of seat portion 12 of shell 20. A second end 42 of first shoulder strap 40 and a second end 47 of second shoulder strap 45 may pass through seat openings 14 on each side of the seat portion 12 of shell 20 and may then be either fixedly or removably coupled to shell 20 underneath the seat portion 12 of shell 20. Alternatively, the first shoulder strap 40 and second shoulder strap 45 may be coupled together underneath the seat portion 12 of shell 20 as a single continuous strap.

It will be appreciated by one skilled in the art that depending on the particular application, a Y buckle 70 may be replaced with one or more buckles with a number of receiving portions appropriate for receiving the number of straps used in the particular application. In the embodiments described herein, a Y buckle 70 is used as there are two shoulder straps and a crotch strap that are removably or fixedly attached to the Y buckle 70. The use and description of a Y buckle 70 herein is not intended to limit the scope of the invention to utilizing only the described type of buckle.

A first chest buckle 75 may be slidingly coupled to the first shoulder strap 40, and a second chest buckle 76 may be slidingly coupled to the second shoulder strap 45, wherein the first chest buckle 75 and the second chest buckle 76 may releasably engage one another to position the first shoulder strap 40 and the second shoulder strap 45 relative to one another.

The crotch strap 50 has a first end 51 and a second end 52. First end 51 of crotch strap 50 passes through openings 14 in the seat portion 12 of shell 20 and may be fixedly or removably coupled to shell 20 underneath the seat portion 12 of shell 20. The second end 52 of crotch strap 50 may be either fixedly or removably coupled to Y buckle 70.

The adjuster assembly 100 is mounted to child restraint 11 at the receiving surface 200. The receiving surface 200 is sized and shaped to allow the mounting of adjuster assembly 100. The receiving surface 200 is typically positioned at approximately the center of the front of the seat portion 12 of the shell 20 as shown in FIG. 7. One skilled in the art will appreciate that the receiving surface 200 may be positioned at any number of positions on the child restraint 11, including but not limited to the bottom or back of the child restraint 11. With reference to FIGS. 7 and 8, receiving surface 200 has adjuster assembly 100 fixedly or removably coupled to the receiving surface 200 by any conventional fastening means including rivets, bolts or screws.

The first end (not pictured) of strap 60 may be coupled to a connecting bar (not pictured) positioned behind the shell 20 of child restraint 11. The second end 67 of strap 60 is laced through adjuster assembly 100, and first shoulder strap 40 and second shoulder strap 45 are also coupled to the connecting bar. Alternatively, second end 67 may be sewn to first ends 41 and 46 of first shoulder strap 40 and second shoulder strap 45 as previously described and may hang downwardly from the adjuster assembly 100. The adjuster assembly 100 may be positioned so that the grip portion 164 is pointing substantially downwardly.

When the adjuster assembly 100 is positioned on child restraint 11, and with the web harness assembly 30 engaged (whereby tongue clips 71 and 72 are coupled to the Y buckle 70), pulling the second end 67 of strap 60 downwards causes the first shoulder strap 40 and the second shoulder strap 45 to move through the at least two back openings 48 of the back portion 16 of shell 20, thereby tightening the web harness assembly 30 toward and against the front surface 22 of shell 20. When in a “closed” position with first plate 120 and second plate 130 biased toward one another, adjuster assembly 100 prevents microslip, or unintended slippage, of strap 60 back through adjuster assembly 100. Microslip back through the adjuster assembly 100 is prevented due to the friction caused by the orientation of the first plate 120 and the second plate 130 which causes the edges of at least one opening 125 and at least two openings 116 to engage strap 60 due to the lacing pattern of strap 60 as shown in FIGS. 3 and 4.

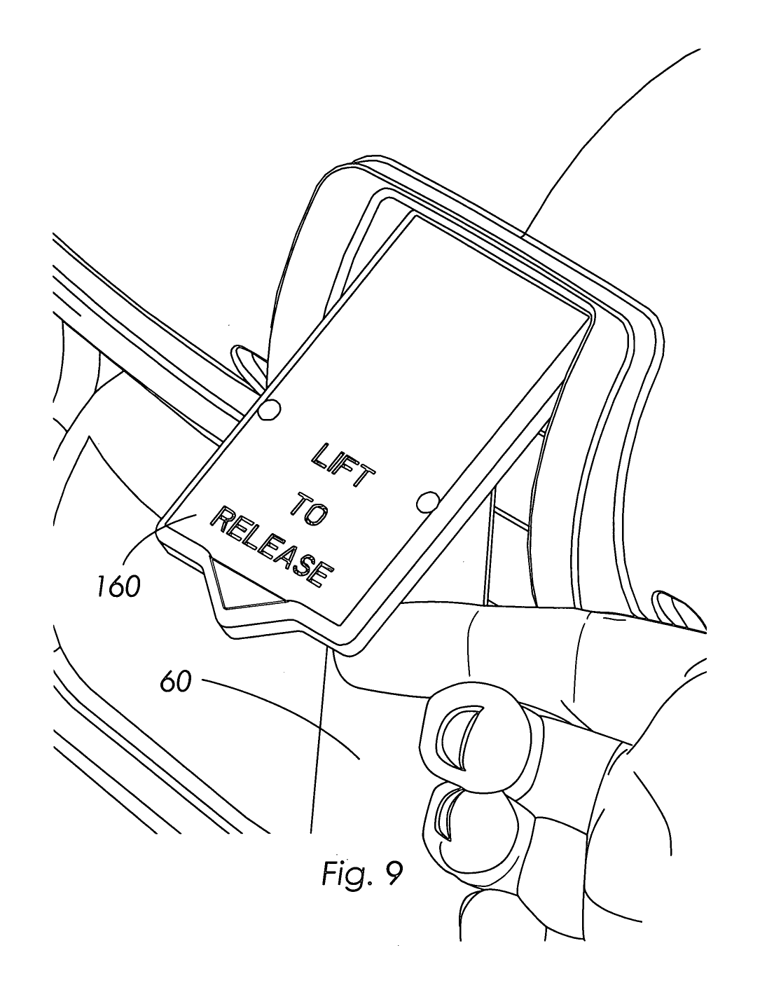

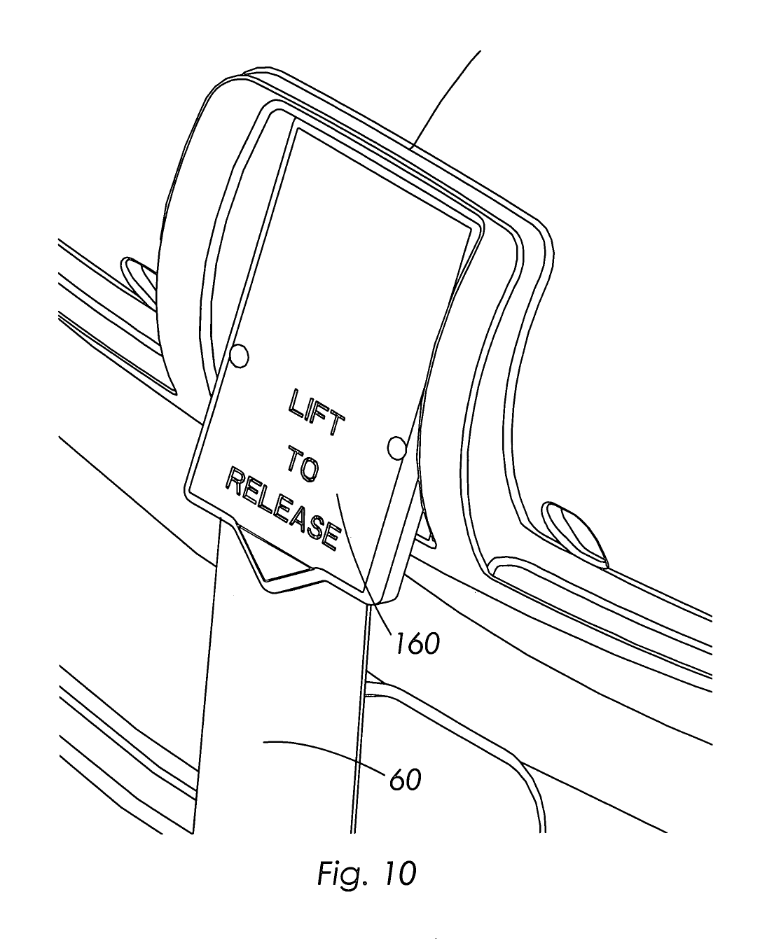

To release or “open” the web harness assembly 30, a user places his or her fingers behind the grip portion 164 of cover plate 160 pulling second plate 130 from first plate 120, thus opening the adjuster assembly 100. A user would need to apply enough pulling force to overcome the biasing of tension spring 150 to move the adjuster assembly 100 from its closed position until first plate 120 and second plate 130 are at least at an angle of approximately 30° to 40° in relation to one another (as shown in FIG. 9). It will be appreciated by one skilled in the art that depending on the specific embodiment of adjuster assembly 100, the angle required to “open” the adjuster assembly may be less than 30° or more than 40°. Once the adjuster assembly 100 is “opened” in this manner, strap 60 may easily move back through plate assembly 110 to allow web harness assembly 30 to loosen, thus allowing the user to freely pull first shoulder strap 40 and second shoulder strap 45 away from the shell 20 while holding the adjuster assembly 100 in an open position. When a user releases cover plate 160, tension spring 150 (or other tension means) returns the adjuster assembly 100 to its “closed” position (as shown in FIG. 10), thereby engaging the strap 60 and preventing movement of strap 60 back through adjuster assembly 100.

While some slippage may occur when first plate 120 and second plate 130 are at an angle slightly under 30° in relation to one another, the friction between strap 60, an opening 125 of first plate 120, and an opening 116 defined in the second plate 130 increases as the angle between first plate 120 and second plate 130 decreases. The increasing friction may further cause any pulling of the strap 60 in the direction of the first end 65 of the strap 60 to urge adjuster assembly 100 into its closed position thereby locking the strap 60 and preventing further movement. Therefore, as force may be placed upon strap 60 (as in a sudden vehicle stop or struggling by the child), adjuster assembly 100 is further urged downward toward the closed position with further force, helping to reduce microslip altogether, and to ensure the restraint of the child within the child restraint 11.

Web harness assembly 30 may be “opened” by pressing a button 73 on Y buckle 70 so that tongue clips 71 and 72 may be released from Y buckle 70, allowing the first shoulder strap 40 and the second shoulder strap 45 to move away from one another. A child (not shown) may then be positioned onto child restraint 11, and the first shoulder strap 40 and the second shoulder strap 45 may be positioned over and in front of the respective shoulders of the child. The crotch strap 50 and Y buckle 70 may then be positioned between the legs of the child. Tongue clips 71 and 72 may then be secured to Y buckle 70 so that the child is positioned between the secured web harness assembly 30 and shell 20.

The tension of web harness assembly 30 may be adjusted by pulling the second end 67 of strap 60 downwards, thereby causing the first shoulder strap 40 and the second shoulder strap 45 to be pulled upwards and toward the back portion 16 of shell 20, thereby tightening the web harness assembly 30 against the child. Conversely, releasing adjuster assembly 100, as described above, would release strap 60, allowing the first shoulder strap 40 and the second shoulder strap 45 to loosen, thereby allowing the child to move more freely, or allowing a user securing an uncooperative child to more easily position the child within the web harness assembly 30 prior to snugly securing the web harness assembly 30 to further restrain the child.

It will be appreciated by one skilled in the art that once a child has been positioned onto child restraint 11, and the web harness assembly 30 and the adjuster assembly 100 have been adjusted as referenced above to properly secure the child, the child may be subsequently secured onto child restraint 11 by way of engaging and disengaging a first chest buckle 75 to a second chest buckle 76. In this manner, a user may “set” the proper adjustment of the web harness assembly 30 and the adjuster assembly 100 to result in a proper “fit” when a child is positioned onto child restraint 11, and the web harness assembly 30 and the adjuster assembly 100 may not need to be adjusted again until the size of the child requires further adjustment.

Although the present invention has been described in considerable detail with reference to certain preferred versions thereof, other versions are possible. For example, while strap 60 has been disclosed herein as being connected to first shoulder strap 40 and second shoulder strap 45 designed to secure the shoulders of a child therein, strap 60 may be attached to or could be the same as crotch strap 50. Further, several configurations of adjuster plates and their respective openings and/or pins may be conceived which allow for adequate friction to preclude microslip when the first plate 120 and the second plate 130 are biased against one another in their closed position. Additionally, as shown in the Figures attached hereto, bar 135 may be formed by creating two openings in second plate 130, thereby reducing the manufacturing costs of the assembly. Therefore, the spirit and scope of the appended claims should not be limited to the description of the preferred versions contained herein.

I claim:

1. An adjuster assembly for adjusting the length of a strap, comprising:
a first plate having a first plate first edge, and at least one first strap opening formed therethough;
a second plate having a second plate first edge and at least two second strap openings formed therethrough;
a hinge coupled to the first plate at the first edge of the first plate and to the second plate at the first edge of the second plate, said hinge allowing the first plate and second plate to pivot with respect to one another;
wherein one end of the strap may be threaded through the at least one first strap opening in the first plate, through one of the at least two strap openings in the second plate, then back through a second of the at least two strap openings in the second plate, and then back through the at least one first strap opening in the first plate so that the strap can be freely pulled through the adjuster assembly in one direction but when pulled in the opposite direction causes the first and second plates to pivot toward one another to prevent the strap from being pulled back through the adjuster assembly in the opposite direction unless and until the second plate is manually pivoted away from the first plate.

2. The adjuster assembly of claim 1, further comprising biasing means for biasing the first plate and the second plate to pivot towards one another.

3. The adjuster assembly of claim 2, wherein the biasing means comprises a spring coupled to the first plate and the second plate.

4. The adjuster assembly of claim 1, further comprising a cover plate mounted over the second plate.

5. The adjuster assembly of claim 4, wherein said cover plate further comprises a grip portion.

6. The adjuster assembly of claim 4, wherein the cover plate further comprises indicia printed or embossed thereon.

7. The adjuster assembly of claim 4, wherein the cover plate is removably attached to the second plate.

8. The adjuster assembly of claim 1, wherein the second plate further comprises a second plate spacer, the second plate spacer connected at a first edge to the first edge of the second plate and the hinge is connected to the second plate spacer at an opposite second edge of said spacer, the second plate spacer off-setting the second plate with respect to the first plate.

9. The adjuster assembly of claim 1, wherein a second end of the elongated strap is attached to the first plate to form a loop at a position that does not interfere with the first end of the strap being pulled though the adjuster so that as said first end of the strap is pulled through the adjuster assembly, the length of the loop of the strap is reduced.

10. An adjuster assembly for adjusting the length of a strap, comprising:
a first plate having a first plate first edge, and at least one first strap opening formed therethough;
a second plate having a second plate first edge and at least two second strap openings formed therethrough, the second plate further comprising a second plate spacer connected at a first edge to the first edge of the second plate;
a hinge coupled to the first plate at the first edge of the first plate and to the second plate spacer at a second edge opposite the first edge of the second plate spacer, said hinge allowing the first plate and second plate to pivot with respect to one another;
a spring coupled to the first plate and the second plate for biasing the first plate and the second plate to pivot towards one another;
a cover plate mounted over the second plate, wherein said cover plate further comprises a grip portion and indicia printed or embossed thereon;
wherein one end of the strap may be threaded through the at least one first strap opening in the first plate, through one of the at least two strap openings in the second plate, then back through a second of the at least two strap openings in the second plate, and then back through the at least one first strap opening in the first plate so that the strap can be freely pulled through the adjuster assembly in one direction but when pulled in the opposite direction causes the first and second plates to pivot toward one another to prevent the strap from being pulled back through the adjuster assembly in the opposite direction unless and until the second plate is manually pivoted away from the first plate; and
wherein a second end of the elongated strap may be attached to the first plate to form a loop at a position that does not interfere with the first end of the strap being pulled though the adjuster so that as said first end of the strap is pulled through the adjuster assembly, the length of the loop of the strap is reduced.

11. A child restraint, comprising:
a shell comprising a seat portion and a back portion;
a harness system mounted to said seat for restraining a child in said seat, said harness system comprising shoulder straps passing over the shoulders of a child when positioned in said seat and said shoulder straps passing through said back portion, said shoulder straps being connected to an adjusting strap that passes under said seat portion;
an adjuster assembly coupled to the shell, the adjuster assembly comprising:
a first plate having a first edge, and at least one first opening formed therethrough;
a second plate having a first edge, and at least two second openings formed therethrough;
a hinge coupled to the first edge of the first plate and to the first edge of the second plate, said hinge allowing the first plate and the second plate to pivot with respect to one another so that said first opening is offset from said second openings;
said adjusting strap being threaded through the at least one first opening in the first plate, through one of the at least two second openings in the second plate, then back through a second of the at least two openings in the second plate, and then back through the at least one first opening in the first plate so that the strap can be pulled through the adjuster assembly in one direction but movement of said strap in the opposite direction causes the first and second plates to pivot toward one another to prevent the strap from being pulled back through the adjuster in the opposite direction unless and until the second plate is pivoted away from the first plate.

12. The child restraint of claim 11, wherein the web harness assembly comprises a crotch strap connected to a Y buckle, and said shoulder straps are removably connected to said Y buckle.

13. The child restraint of claim 11, further comprising biasing means for biasing the first plate and the second plate to pivot towards one another.

14. The child restraint of claim 13, wherein the biasing means comprises a spring coupled to the first plate and the second plate.

15. The child restraint of claim 11, further comprising a cover plate mounted over the second plate.

16. The child restraint of claim 15, wherein said cover plate further comprises a grip portion.

17. The child restraint of claim 15, wherein the cover plate further comprises indicia printed or embossed thereon.

18. The child restraint of claim 15, wherein the cover plate is removably attached to the second plate.

19. The child restraint of claim 11, wherein the second plate further comprises a second plate spacer, the second plate spacer connected at a first edge to the first edge of the second plate and the hinge is connected to the second plate spacer at an opposite second edge of said spacer, the second plate spacer off setting the second plate with respect to the first plate.

20. The child restraint of claim 11, wherein a second end of the elongated strap is attached to the first plate to form a loop at a position that does not interfere with the first end of the strap being pulled though the adjuster so that as said first end of the strap is pulled through the adjuster assembly, the length of the loop of the strap is reduced.
